(19) United States
(12) Patent Application Publication
(10) Pub. No.: US 2010/0085763 A1
(43) Pub. Date: Apr. 8, 2010

(54) LENS FOR A LIGHT EMITTING DIODE AND MANUFACTURING METHOD THEREFOR

(75) Inventor: Jorge Miguel Aguglia, Lecce (IT)

Correspondence Address: SUGHRUE MION, PLLC, 2100 PENNSYLVANIA AVENUE, N.W., SUITE 800, WASHINGTON, DC, 20037, US

(73) Assignee: SIC Divisione Elettronica S.R.L., Leece (IT)

(21) Appl. No.: 12/524,520

(22) PCT Filed: Jan. 26, 2007
(86) PCT No.: PCT/IT07/00052

§ 371 Date: Aug. 11, 2009

(51) Int. Cl. F21V 5/00; G02B 3/02; B29D 11/00

(52) U.S. Cl. 362/311.06; 359/708; 264/1.9

(57) ABSTRACT

The present invention refers to a lens for a signal light, which lens is configured to convert a first distribution of light rays emitted from a light source (23) into a second distribution of light rays. The lens comprises at least three sectors and each lens sector has at least one internal surface (42i-44i) and at least one corresponding external surface (42e-44e) arranged to convert the first distribution into the second distribution. The internal (42i-44i) and external (42e-44e) surfaces form an overall internal surface (40i. 140i) and a corresponding external surface (40e, 140e) free from undercuts. At least one sector has an internal surface (43i) arranged to refract the light rays emitted from the light source (23), and at least two external surfaces (43e1, 43e2), wherein a first of the two external surfaces is arranged to reflect the rays refracted by the internal surface (43i) and a second of the two external surfaces (43e2) is arranged to refract the rays reflected by the first external surface (43e1). The invention also concerns a method of manufacturing the lens and a signal light, in particular for naval use.

### TECHNICAL FIELD

The present invention generally relates to lenses for signal lights using light emitting diodes (LEDs). More particularly, the invention relates to lenses for signal lights for naval use, which enable orienting the light emitted from the diodes in predetermined directions or sectors.

### BACKGROUND ART

Lenses for light emitting devices, such as for instance light emitting diodes or LEDs, are well known.

For instance, a lens for an LED arranged to convert a first light distribution emitted from an LED into a second distribution is known from publication EP01255132 A1. More particularly, according to the prior art document, considering a reference base of the LED and an axis orthogonal to the base and passing through a symmetry axis of the base, the lens is configured to orient light on the plane substantially orthogonal to the base, i.e. on a plane that here is conventionally referred to as horizontal plane.

A first problem with that prior art is that the lens is shaped by considering the LED a point-like source. As known, the LED, in particular in applications providing for orienting light in predetermined sectors, cannot be considered a point-like source. Hence, the lens of that prior art, being shaped based on approximate hypotheses, cannot but approximately obtain the emitted light orientation in the predetermined sector.

Another problem with that prior art is that the lens walls exhibit acute angles, i.e. so-called undercut surfaces, so that the lens manufacture requires to use complex moulds, since the moulds must include additional movable inserts to obtain the undercut surfaces.

A lens arranged to convert a first light distribution, emitted for instance from an LED, into a second light distribution, without requiring the provision of reflecting parabolas, is also known from publication U.S. Pat. No. 6,896,381. In particular, according to that prior art, light is oriented along the axis orthogonal to the LED base.

That prior art takes into account that the LED is not a point-like light source, but it has the problem of exploiting multiple reflections between pairs of lens surfaces in order to orient light in the predetermined sector corresponding to the LED axis.

As a skilled in the art will readily appreciate, exploiting multiple reflections on the lens surfaces in order to orient light results in a non-optimal level of light attenuation, since light must travel over multiple paths inside the lens.

Moreover, exploiting the reflection phenomenon, in particular multiple reflections, entails the further problem that, since the lens surfaces generally are not perfectly smooth, reflection on those surfaces is not perfect and gives rise to unavoidable and undesired refraction phenomena. Of course, as the number of reflections increases, the undesired refraction phenomena increase too.

By summarizing, the Applicant has noticed that the prior art in the field of the lenses for LEDs, which lenses are shaped to orient light in predetermined sectors, has at least problems of either excessive simplification and manufacture difficulty, or low efficiency, since multiple reflections inside the lens are required.

### DISCLOSURE OF THE INVENTION

It is an object of the present invention to provide a lens that enables overcoming the above problems of the prior art.

The above object is achieved by the lens for a diode signal light as claimed.

The present invention also relates to a method of manufacturing the lens for a diode signal light and the relevant signal light.

The claims are integral part of the technical teaching provided here in respect of the invention.

According to a preferred embodiment, the lens is arranged to convert, through an internal surface and a corresponding external surface, a first light ray distribution, as emitted from a light source over a hemispherical surface, into a second light ray distribution by using a plurality of sectors into which the lens is subdivided, wherein at least, one of the sectors operates by reflecting light rays and wherein the internal and external surfaces are free from undercut.

According to a further feature of the present invention, the sector operating by reflection includes an internal sector surface, arranged to refract the light rays emitted from the light source, and at least two external sector surfaces, wherein a first of the two external sector surfaces is arranged to reflect the rays refracted by the internal sector surface and a second of the two external sector surfaces is arranged to refract the rays reflected by the first external sector surface.

According to another feature of the invention, the second light ray distribution corresponds to a cylindrical sector of ±10° relative to the base plane of the hemispherical light emission surface in the LED.

According to yet another feature of the invention, the second light ray distribution corresponds to a sector of ±10° about the axis orthogonal to the base plane of the hemispherical light emission surface in the LED.

### BRIEF DESCRIPTION OF DRAWINGS

These and further features and advantages of the present invention will appear more clearly from the following detailed description of preferred embodiments, provided by way of non-limiting examples with reference to the attached drawings, in which components designated by same or similar reference numerals indicate components having same or similar functionality and construction and wherein:

FIGS. 1 and 2a show a cross-sectional view of a signal light according to a first embodiment of the present invention;

FIG. 2b shows a constructional detail of the lens of the signal light of FIG. 2a;

FIG. 3a shows a cross-sectional view of a signal light according to a second embodiment of the present invention;

FIG. 3b shows a perspective view of the lens of the signal light of FIG. 3a;

FIG. 3c shows a constructional detail of the lens of the signal light of FIG. 3a.

### BEST MODE FOR CARRYING OUT THE INVENTION

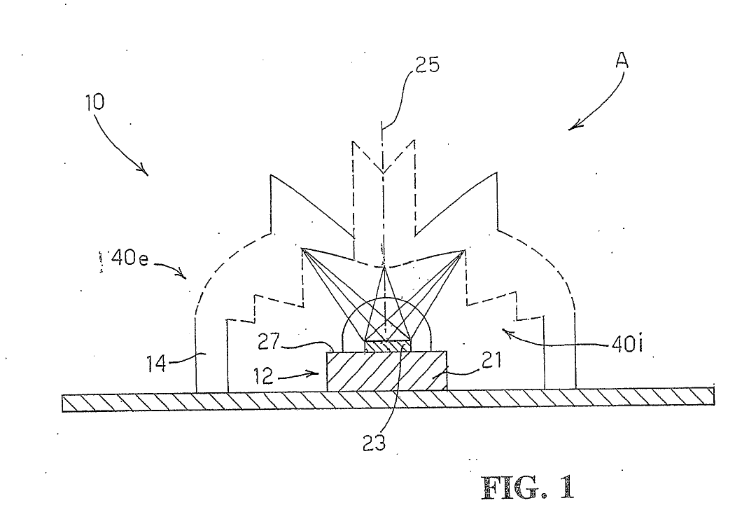

Referring to FIG. 1 and in accordance with a first embodiment, a signal light 10 comprises, according to the present invention, a lens 14 and a light emitting diode (LED) 12, having a base 21 with a base plane 27, and a light source 23 arranged to emit light rays over a hemisphere about an axis 25 orthogonal to the base. According to the first embodiment, lens 14 is arranged to distribute the light rays, as it will be disclosed in detail below, over an angular sector orthogonal to axis 25, or horizontal sector, within a predetermined angle, for instance an angle of ±10° relative to the horizon.

In the first embodiment, signal light 10, shown in a cross sectional view obtained by means of a plane orthogonal to base 21 and passing through axis 25, is such as to meet the standards issued by Registro Italiano Navale in respect of “Posizionamento dei fanali e dei segnali e dettagli costruttivi relativi”, in particular at clause 10, “Settori verticali”.

According to the present exemplary embodiment, therefore, the lens is arranged to distribute the light rays emitted from light source 23 over a cylindrical surface within ±10° relative to the horizon. Actually, that feature is such as to fully meet said standard.

LED 12, of known type, is for instance a 3 W LED from company LUMILEDS, model LUXEON EMITTER III, including a light source 23 having a square emission surface whose side is 1.38 mm long.

Light source 23 of LED 12 includes an emission surface arranged to emit light over a hemisphere (upper hemisphere) and, in particular, from first and second emission ends 23a and 23b, respectively, and from an emission centre 23c of the emission surface. More particularly, the present description assumes that LED 12 emits light rays in at least four emission or distribution sectors, of which at least three are significant.

Lens 14, for instance a lens made of polycarbonate having, for instance, index of refraction n2=1.58 and manufactured by injection moulding, has an internal surface 40i and an external surface 40e with hemispherical shape. In the first embodiment, the lens is shaped by assuming square light sources 23 with a 1.9 mm long side, which corresponds to the maximum size envisaged for 5 W LEDs, as a skilled in the art will readily appreciate.

Of course, in other embodiments, the LED may be any LED for naval use, with a light source 23 whose side or diameter is less than or equal to 1.9 mm.

According to the present exemplary embodiment, the lens is shaped by taking into account both rays outgoing from ends 23a and 23b, respectively, and rays outgoing from centre 23c of light source 23.

According to the present exemplary embodiment, internal and external surfaces 40i and 40e of lens 14 are symmetrical with respect to axis 25: thus, for sake of simplicity of description, a half-plane A is illustrated here which lies between base plane 27, conventionally at 0°, and axis 25, conventionally at 90°.

Internal and external surfaces 40i and 40e of the lens are divided into 4 sectors or internal and external surfaces 41i, 42i, 43i, 44i and 41e, 42e, 43e, 44e, respectively, associated with each other and corresponding to the emission sectors of LED 12.

The first internal and external sectors 41i and 41e, respectively, correspond to the region where light rays are emitted from LED 12 within an interval of 10°, at angles ranging from 0° to 10° relative to base plane or horizontal plane 27.

In such a region, where as known light emission is low, the walls of internal surface 41i and the associated external surface 41e are orthogonal to base plane 27, so that they do not deflect rays emitted from LED 12. In other embodiments, such surfaces 41i and 41e, respectively, could even be omitted since the region is a low emission one.

The second internal and external sectors 42i and 42e, respectively, correspond to the region where light rays are emitted from LED 12 within an interval of 40°, at angles ranging from 10° to 50° relative to base plane 27.

In such a region, internal surface 42i comprises for instance two walls orthogonal to base plane 27, and external surface 40e comprises a corresponding wall that is progressively curved from an angle orthogonal to base plane down to an angle of about 63°, so as to orient, by refraction, light rays emitted from emission centre 23c in an approximately horizontal direction, and light rays emitted from the first and second emission ends within ±10° relative to horizontal plane 27.

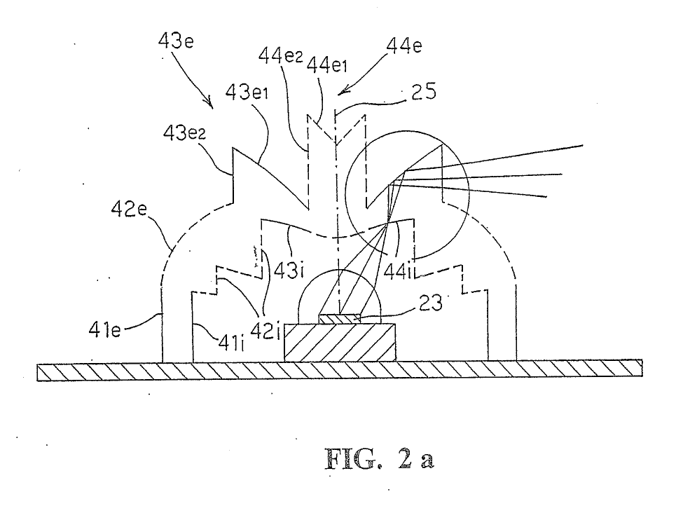

The third internal and external sectors 43i and 43e, respectively, correspond to the region where light rays are emitted from LED 12 within an interval of 20°, at angles ranging from 50° to 70° relative to base plane 27 (FIG. 1, FIG. 2).

In such a region, internal surface 43i is curved so that light rays emitted from centre 23c form, with the perpendicular to surface 43i, an angle of incidence θ1 of about 45°, e.g. 43.12°, and light rays emitted from the first end 23a and the second end 23b of light source 23 of LED 12 form angles of incidence ranging from about 60°, e.g. 59.04°, to about 25°, e.g. 26.21°, respectively.

The corresponding external surface 43e comprises two walls 43e1 and 43e2, respectively.

The first wall 43e1 is curved so that light rays emitted from the first end 23a and the second end 23b and refracted by internal surface 43i form, with the perpendicular to external surface 43e1, angles of incidence θ2 ranging from about 60°, e.g. 57.85°, to about 45°, e.g. 44.92°. Actually, such angles are capable of reflecting light rays, as disclosed hereinafter in detail.

The second wall 43e2 is substantially orthogonal to base plane 27.

Such a configuration, as a skilled in the art will readily appreciate, ensures the orientation of the light rays through a single reflection.

Indeed, angles of incidence θ2 on the first external wall 43e1 exceed the minimum angle necessary in order that light rays emitted from emission centre 23c and light rays emitted from the first and second emission ends 23a and 23b are reflected and oriented in horizontal direction and within ±10 relative to horizontal plane 27°, respectively.

For instance, taking into account that the index of refraction of light in air is n1=1 and in polycarbonate is n2=1.58, the angles at which rays emitted from centre 23c and from the first and second emission ends 23a and 23b will continue their paths within lens 14 can be determined.

Rays 23c, 23a and 23b, respectively, will propagate within the lens as long as they reach external surface 43e, but, in order they can be reflected, they must form angles of incidence exceeding a critical angle θr with the perpendicular to surface 43e. In the example, the critical angle is θr=arcsin(n2/n1*sin θ2) and corresponds to an angle of about 40°, e.g. 39.26°

Reflected rays are transmitted towards the second external wall 43e2 and slightly refracted, so that light rays are oriented within ±10° relative to horizontal plane 27.

The fourth internal and external sectors 44i and 44e, respectively, correspond to the region where light rays are emitted from LED 12 within an interval of 20°, at angles ranging from 70° to 90° relative to base plane 27.

In such a region, internal surface 44i comprises for instance a convex wall, and external surface 44e comprises a first wall 44e1, at an angle of about 45° relative to base plane 27 and a second wall 44e2, orthogonal to base plane 27.

Internal surface 44i is configured to orient light rays coming from centre 23c and from ends 23a and 23b of light source 23 in a manner substantially equivalent to that described for third sector 43i.

More particularly, in a manner equivalent to what has been described for the third external sector 43e, external surface 44e has its first wall 44e1 configured to orient in horizontal direction, by reflection, light rays emitted from centre 23c and from the first end 23a and the second end 23b and refracted by internal surface 44i.

The rays reflected by the first external wall 44e1 are transmitted towards the second external wall 44e2 and slightly refracted so that light rays are oriented within ±10° relative to horizontal plane 27.

Such a configuration too, as a skilled in the art will readily appreciate, ensures light ray orientation through a single reflection.

By summarizing, the above example has been realised by taking into account all rays outgoing from the LED and by building the input and output lens walls so as to obtain the desired result, namely rays outgoing at an angle ranging from −10° to +10° relative to horizontal plane 27 and with a good light flux uniformity.

Lens 14 as described meets the requirements of:
converting a first distribution of light rays emitted from light source 23 into a second distribution, wherein, in particular, the second distribution corresponds to a cylindrical sector within ±10° relative to horizontal plane 27;
being easy to manufacture, since it is free from undercut surfaces;
having high efficiency, since it exhibits, in limited and specific sectors, a single reflection on the lens walls.

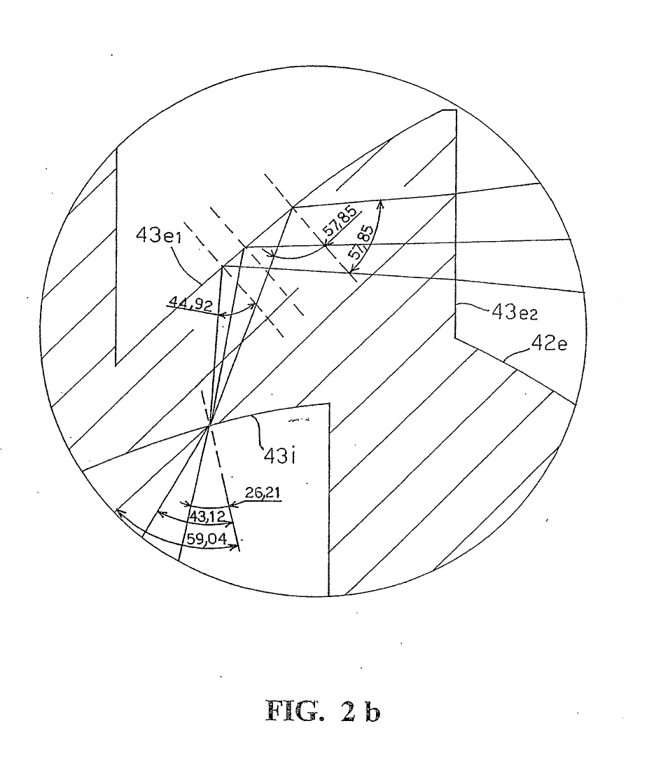

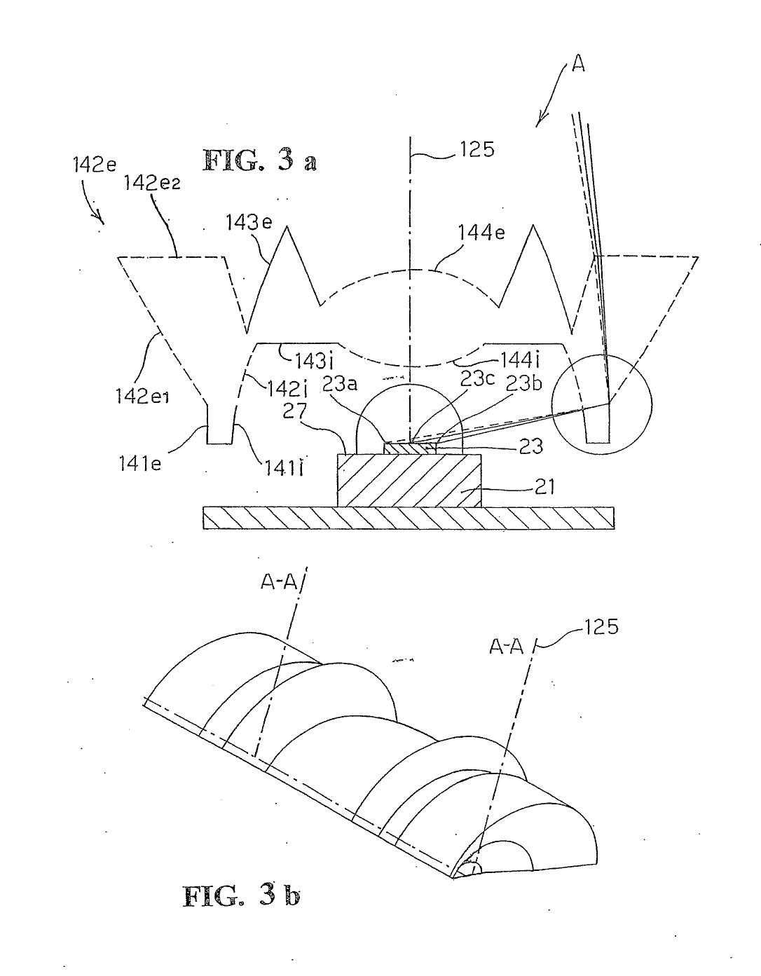

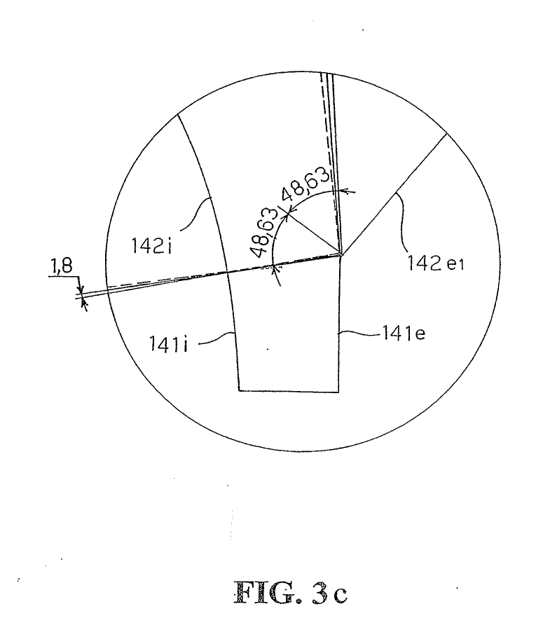

Referring to FIGS. 3a, 3b and 3c and in accordance with a second embodiment, a signal light 110 comprises, according to the present invention, a lens 114 and a light emitting diode (LED) 12, having a base 21 with a base plane 27 and a light source 23 arranged to emit light rays over a hemisphere about an axis (LED axis) 125 orthogonal to base 21.

LED 12 is for instance of the type already described in connection with the first embodiment, and lens 114 is for instance made of polycarbonate and manufactured by injection moulding.

In the second embodiment, lens 114, which is shown in a perspective view (FIG. 3b) and in a cross sectional view along a plane A-A orthogonal to base 21 and passing through axis 125 (FIG. 3a), is such as to meet the standards issued by Registro Italiano Navale in respect of “Posizionamento dei fanali e dei segnali e dettagli costruttivi relativi”, in particular clause 9—“Settori orizzontali”.

In particular, and as described in detail below, lens 114 is arranged to distribute the light rays on plane A-A within an angle of ±10° about axis 125 and it “covers”, according to the standards issued by Registro Italiano Navale, a cylinder sector extending from 0° to 112.5°, as it is readily apparent from the perspective view.

In particular, the lens preferably comprises an internal surface 140i and an external surface 140e developing over a cylinder sector, which, depending on various embodiments, extends from 0° to an angle smaller than or equal to 180°.

In other embodiments, the lens may even have a hemispherical shape, without departing from the scope of what is described and claimed.

In the second embodiment too, lens 114 is shaped by considering square light sources 23 with a 1.9 mm long side, which corresponds to the maximum size envisaged for 5 W LEDs, as a skilled in the art will readily appreciate. Of course, in other embodiments, the LED may be any LED for naval use, with a light source 23 whose side or diameter is less than or equal to 1.9 mm.

According to the present exemplary embodiment, the lens is shaped by taking into account both light rays outgoing from ends 23a and 23b, respectively, and rays outgoing from centre 23c of light source 23.

According to the present exemplary embodiment, internal and external surfaces 140i and 140e of lens 114 are symmetrical on transversal plane A-A passing through axis 125: thus, for sake of simplicity of description, a half-plane A lying between base plane 27, conventionally at 0°, and axis 125, conventionally at 90°, is illustrated here.

Internal and external surfaces 140i and 140e of the lens are divided into 4 sectors or internal and external surfaces 141i, 142i, 143i, 144i and 141e, 142e, 143e, 144e, respectively, associated with each other and corresponding to the emission sectors of LED 12.

The first internal and external sectors 141i and 141e, respectively, correspond to the region where light rays are emitted from LED 12 within an interval of 10°, at angles ranging from 0° to 10° relative to base plane or horizontal plane 27. Such a region, where as known light emission is low, is managed in transparent manner, by providing walls orthogonal to base plane 27 for internal surface 141i and the associated external surface 141e. That configuration, which is such that it does not deflect rays emitted from LED 12, entails the provision of a screen, which is arranged either to attenuate the emitted rays or, in the alternative, to reflect them and direct them towards axis 125 orthogonal to the base 21.

Of course, in further embodiments, such surfaces 141i and 141e, respectively, could even be omitted since the region is a low emission one and can be screened with suitable reflecting screens.

The second internal and external sectors 142i and 142e, respectively, correspond to the region where light rays are emitted from LED 12 within an interval of 20°, at angles ranging from 10° to 30° relative to base plane 27.

In such a region, internal surface 142i is curved so that rays outgoing from centre 23c of light source 23 form, with the perpendicular to surface 142i, an angle of incidence θ1 for instance of about 0°, and light rays emitted from the first end 23a and the second end 23b of light source 23 form angles of incidence for instance within ±1.8°.

The corresponding external surface 142e comprises two walls 142e1 and 142e2, respectively. The first wall 142e1 is curved so that light rays emitted from the first end 23a and the second end 23b and refracted by internal surface 142i form, with the perpendicular to external surface 142e1, angles of incidence θ2 exceeding 45°, for instance angles exceeding 48.63°, capable of reflecting light rays. The second wall 142e2 is substantially orthogonal to base plane 27.

Such a configuration, as a skilled in the art will readily appreciate, ensures the orientation of the light rays through a single reflection.

Indeed, the angles of incidence θ2 on the first external wall 142e1 exceed the minimum (critical) angle wherein refraction occurs. Thus, light rays emitted from emission centre 23c and light rays emitted from the first and second emission ends 23a and 23b are reflected and oriented towards axis 125 and within ±10° relative to the axis, respectively.

For instance, taking into account that index of refraction of light in air is n1=1 and in polycarbonate is n2=1.58, the angle at which rays emitted from centre 23c and the first and second emission ends 23a and 23b will continue their paths within lens 114 can be determined.

Rays 23c, 23a and 23b, respectively, will propagate within the lens as long as they reach external surface 142e1, but, in order they can be reflected, they must form angles of incidence exceeding a critical angle θr with the perpendicular to surface 142e1. In the example, the critical angle is θr=arcsin (n2/n1*sin θ2) and corresponds to an angle of about 40°, e.g. 39.26°.

Reflected rays are transmitted towards the second external wall 142e2 and slightly refracted so that the light rays are oriented within ±10° relative to axis 125 of LED 12.

The third internal and external sectors 143i and 143e, respectively, correspond to the region where light rays are emitted from LED 12 within an interval of 20°, at angles ranging from 30° to 50° relative to base plane 27.

In such a region, internal surface 143i comprises for instance a wall substantially orthogonal to axis 125, and external surface 143e comprises a corresponding wall that is curved in regular manner from an angle of about 20° up to an angle of about 28°, so as to orient, by refraction, light rays emitted from emission centre 23c within ±5°, and light rays emitted from the first and second ends 23a and 23b within ±10°, respectively.

The fourth internal and external sectors 144i and 144e, respectively, correspond to the region where light rays are emitted from LED 12 within an interval of 40°, at angles ranging from 50° to 90° relative to base plane 27.

In such a region, internal surface 144i and external surface 144e form a biconvex lens. In particular, internal surface 144i comprises for instance a convex wall that is curved in regular manner with a curvature opposite to that of external surface 144e, so as to form the biconvex lens. Internal and external surfaces 144i and 144e, respectively, are arranged to orient, by refraction, light rays emitted from centre 23c of light source 23 within ±5°, and light rays emitted from ends 23a and 23b within ±10°.

The above example has been realised by taking into account all rays outgoing from the LED and by building the input and output lens walls so as to obtain the desired result, namely rays outgoing at angles ranging from +10° to −10° relative to vertical axis 125 and with a good light flux uniformity.

Lens 114 as described meets the requirements of:
converting a first distribution of light rays emitted from light source 23 into a second distribution, wherein, in particular, the second distribution corresponds to a sector within ±10° relative to plane A-A passing through axis 125 of LED 12; the second distribution being limited, in the example, within a cylinder sector extending from 0° to 112.5°;
being easy to manufacture, since it is free from undercut surfaces;
having high efficiency, since it exhibits, in limited and specific sectors, a single reflection on the lens walls.

By summarizing, signal light 10 or 110 according to the present invention is particularly effective and easy to manufacture.

Indeed, by subdividing the light ray emission sectors into at least four sectors and by subdividing accordingly the associated lens, and by associating every time the internal surfaces of each lens sector with the external surfaces of the corresponding sector, a single reflection can be obtained inside the lens, along with surfaces that can be readily formed by injection moulding.

Of course, obvious changes and/or variations to the above disclosure are possible, as regards dimensions, shapes, materials and components, as well as details of the described construction and operation method without departing from the scope of the invention as defined by the claims that follow.

1-15. (canceled)

16. Method for manufacturing a lens arranged to convert a first distribution of light rays emitted from a diode light source into a second distribution of light rays, characterised by the steps of:
subdividing the first distribution into at least three sectors of a hemisphere having a base plane and an axis orthogonal to the base plane;
shaping the lens so that it comprises a number of sectors corresponding to the subdivision of the first distribution, each sector in said lens including at least one internal surface (42i-44i, 142i-144i) and at least one corresponding external surface (42e-44e, 142e-144e), said internal (42i-44i, 142i-144i) and external (42e-44e, 142e-144e) surfaces forming an overall internal surface (40i, 140i) and a corresponding external surface (40e, 140e) free from undercut;
shaping at least one of said sectors so that it includes one internal sector surface (43i; 142i) arranged to refract said light rays emitted from the light source, and at least two external sector surfaces (43e1, 43e2, 142e1, 142e2), wherein a first of the two external sector surfaces is arranged to reflect the rays refracted by said internal sector surface (43i; 142i) and a second of the two external sector surfaces (43e1, 43e2, 142e1, 142e2) is arranged to refract the rays reflected by said first external sector surface (43e1; 142e1).

17. The method as claimed in claim 16, characterised by the steps of:
shaping a first sector so that it includes at least one internal first sector surface (42i) and at least one external first sector surface (42e) arranged to obtain said second distribution by refraction;
shaping a second sector so that it includes at least one internal second sector surface (43i) and at least one external second sector surface (43e) arranged to obtain said second distribution by reflection;
shaping a third sector so that it includes at least one internal third sector surface (44i) and at least one external third sector surface (44e) arranged to obtain said second distribution by reflection;
said second distribution corresponding to a cylindrical sector on the base plane of the hemisphere.

18. The method as claimed in claim 16, characterised in that said second distribution corresponds to a cylindrical sector of ±10° on the base plane of the hemisphere.

19. The method as claimed in claim 17, characterised in that said second distribution corresponds to a cylindrical sector of ±10° on the base plane of the hemisphere.

20. The method as claimed in claim 16, characterised by the steps of:
shaping a first sector so that it includes at least one internal first sector surface (142i) and at least one external first sector surface (142e) arranged to obtain said second distribution by reflection;
shaping a second sector so that it includes at least one internal second sector surface (143i) and at least one external second sector surface (143e) arranged to obtain said second distribution by refraction;
shaping a third sector (144i, 144e) so that it includes at least one internal third sector surface and at least one external third sector surface arranged to obtain said second distribution by refraction;
said second distribution corresponding to a predetermined sector about the hemisphere axis.

21. The method as claimed in claim 16, characterised in that said second distribution corresponds to a sector of ±10° about the hemisphere axis.

22. The method as claimed in claim 20, characterised in that said second distribution corresponds to a sector of ±10° about the hemisphere axis.

23. A lens for a signal light, which lens is configured to convert a first distribution of light rays emitted from a light source into a second distribution of light rays, said light source being arranged to emit said light rays over a hemisphere having a base plane and an axis orthogonal to the base plane, said lens comprising:
at least three sectors, each sector in said lens including at least one internal surface (42i-44i, 142i-144i) and at least one corresponding external surface (42e-44e, 142e-144e) arranged to convert said first distribution into said second distribution; at least one of said sectors comprising one internal sector surface (43i; 142i) arranged to refract said light rays emitted from the light source, and at least two external sector surfaces (43e1, 43e2, 142e1, 142e2), wherein a first of the two external sector surfaces is arranged to reflect the rays refracted by said internal sector surface (43i; 142i) and a second of the two external sector surfaces (43e1, 43e2, 142e1, 142e2) is arranged to refract the rays reflected by said first external sector surface (43e1; 142e1);
said lens being characterised in that said internal (42i-44i, 142i-144i) and external (42e-44e, 142e-144e) surfaces form an overall internal surface (40i, 140i) and a corresponding external surface (40e, 140e) free from undercut.

24. The lens for a signal light as claimed in claim 23, characterised in that it is manufactured by injection moulding.

25. The lens for a signal light as claimed in claim 23, characterised in that it is manufactured in polycarbonate material.

26. The lens for a signal light as claimed claim 23, characterised in that it comprises:
a first sector having at least one internal first sector surface (42i) and at least one external first sector surface (42e) arranged to obtain said second distribution by refraction;
a second sector having at least one internal second sector surface (43i) and at least one external second sector surface (43e) arranged to obtain said second distribution by reflection;
a third sector having at least one internal third sector surface (44i) and at least one external third sector surface (44e) arranged to obtain said second distribution by reflection;
said second distribution corresponding to a cylindrical sector on the base plane of the hemisphere.

27. The lens for a signal light as claimed in claim 23, characterised in that said second distribution corresponds to a cylindrical sector of ±10° on the base plane of the hemisphere.

28. The lens for a signal light as claimed in claim 26, characterised in that said second distribution corresponds to a cylindrical sector of ±10° on the base plane of the hemisphere.

29. The lens for a signal light as claimed claim 23, characterised in that it comprises:
a first sector having at least one internal first sector surface (142i) and at least one external first sector surface (142e1) arranged to obtain said second distribution by reflection;
a second sector having at least one internal second sector surface (143i) and at least one external second sector surface (143e) arranged to obtain said second distribution by refraction;
a third sector (144i, 144e) having at least one internal third sector surface (144i) and at least one external third sector surface (144e) arranged to obtain said second distribution by refraction;
said second distribution corresponding to a predetermined sector about the hemisphere axis.

30. The lens for a signal light as claimed in claim 23, characterised in that said second distribution corresponds to a sector of ±10° about the hemisphere axis.

31. The lens for a signal light as claimed in claim 29, characterised in that said second distribution corresponds to a sector of ±10° about the hemisphere axis.

32. A diode signal light, in particular for naval use, comprising:
a light source having a predetermined emission surface and arranged to emit a first light ray distribution from said emission surface, said emission surface having an emission centre (23c), a first end (23a) associated with a first edge of the emission surface, and a second end (23b) associated with an edge opposite the first edge, characterised by:
a lens for a signal light as claimed in claim 21.

33. A diode signal light as claimed in claim 32, characterised in that said emission surface has a size smaller than or equal to 1.9 mm.

34. A diode signal light as claimed in claim 32, characterised in that said emission source (23) is a LED with a power in the range 3 to 5 W.
